(19) United States
(12) Patent Application Publication
(10) Pub. No.: US 2023/0287912 A1
(43) Pub. Date: Sep. 14, 2023

(54) BLANKET CLAMP WITH RATCHET MECHANISM

(71) Applicant: Adam J. Kriz, Grain Valley, MO (US)

(72) Inventor: Adam J. Kriz, Grain Valley, MO (US)

(21) Appl. No.: 18/121,161

(22) Filed: Mar. 14, 2023

Related U.S. Application Data
(60) Provisional application No. 63/319,649, filed on Mar. 14, 2022.

(51) Int. Cl. F16B 2/18; H02G 1/02

(52) U.S. Cl. CPC F16B 2/185; H02G 1/02

(57) ABSTRACT

A blanket clamp which includes first and second lever arm each with a handle and an upper curved jaw. The first and second lever arms cross over each other and are secured together at a center pivot point, with a torsion spring positioned at the pivot point and configured to bias the upper jaws of the clamp in an open position. A ratchet mechanism configured to lock the clamp in a desired closed or partially closed position includes a toothed portion attached to or formed on the first lever arm and a rotating, thumb-actuated engagement lever pivotably attached to the second lever arm. The thumb-actuated engagement lever includes a protruding cam portion for engagement with the fixed tooth section on the first lever arm. A lever spring holds the trigger and cam in place against the toothed portion of the first lever arm.

### CROSS-REFERENCE TO RELATED APPLICATION

This application claims priority in U.S. Provisional Patent Application No. 63/319,649 Filed Mar. 14, 2022, which is incorporated herein by reference.

### BACKGROUND OF THE INVENTION

### 1. Field of the Invention

The present invention relates generally to clamps and method for use thereof, and more specifically to a blanket clamp system or securing an electrically insulating blanket to an electrical distribution line.

### 2. Description of the Related Art

Electrical linemen rely on various forms of personal protective equipment to allow them to safely work with, and in proximity to, high voltage electrical lines. For example, linemen regularly use insulating gloves and sleeves, hard hats, face shields, insulated tools, as well as measuring equipment such as voltmeters and voltage detectors to ensure their safety while working in high voltage environments.

In addition, electrically insulating blankets are commonly used to cover nearby electrical lines to prevent inadvertent contact by the lineman with those lines, or to prevent inadvertent contact of tools or other equipment with the electrical line. Insulating blankets are typically made of rubber and are available in various insulating grades for use with various voltages, with thinner rubber blankets typically rated for use only with lower voltages and thicker rubber blankets rated for use with higher voltages.

In use, the insulating blanket is draped over an electrical line and secured in place using one or more blanket clamps to provide an insulating barrier surrounding the power line. Typical blanket clamps are made from an electrically insulating material, such as plastic, and use a torsion spring to secure the side-by-side jaws of the plier-like clamp around the blanket and underlying power line to keep the blanket in place. With a plurality of blanket clamps placed along the draped blanket, the blanket is generally secured to the power line to provide protection to the lineman.

While useful, known blanket clamp designs are not without drawbacks. For example, securement of the clamp to the line relies entirely on the bias or strength of the torsion spring to secure the jaws of the clamp in a closed position. For example, while a clamp having a torsion spring of low bias would allow the lineman to easily open the jaws to place it around the blanket and line, such a clamp would provide minimal holding ability. Likewise, a clamp having a torsion spring of high bias would provide better securement of the blanket to the powerline but may be unwieldly for the lineman to operate. Thus, the strength of the torsion spring in a typical blanket clamp requires a compromise between how tightly the clamp will secure the blanket to the power line and the ease of operation for the lineman in placing the clamp.

Furthermore, because typical blanket clamps rely on the bias or strength of the torsion spring to secure the blanket, it is common for movement of the blanket to overcome the bias of the torsion spring, allowing the blanket to move, or in some cases, pull free from the blanket clamp. For instance, a wind gust against an extended blanket can provide a significant force against the spring bias of the blanket clamp, a common occurrence when working on overhead lines outdoors.

Thus, it can be seen that there is a need in the art for a blanket clamp that provides ease of use and improved securement of insulating electrical blankets to power lines. Heretofore there has not been available a system or method for an electrical blanket clamp with the advantages and features of the present invention.

### BRIEF SUMMARY OF THE INVENTION

The present invention is directed to a blanket clamp with ratchet mechanism for securing a protective electrically insulating blanket to an electrical line, such as a power distribution line.

In an exemplary embodiment, the blanket clamp includes first and second lever arms, each extending from a generally straight lower protruding handle to an upper curved jaw. The first and second lever arms cross over each other and are secured together at a center pivot point, with a torsion spring positioned at the pivot point and configured to bias the upper jaws of the clamp in an open position.

A ratchet mechanism configured to lock the clamp in a desired closed (or partially closed) position comprises a fixed toothed section attached to or formed on the first lever arm and a rotating, thumb-actuated engagement lever pivotably attached to the second lever arm. The thumb-actuated engagement lever on the second lever arm comprises an elongate portion extending outwardly for actuation by a user's thumb and a protruding cam portion for engagement with the fixed tooth section on the first lever arm. A lever spring attached to the second lever arm is positioned against the elongated portion of the thumb-actuated engagement lever so that in the normal, non-actuated position, the cam portion is engaged against the fixed toothed section.

The engagement between the thumb-actuated engagement lever and the fixed tooth portion thus provides a ratchet mechanism to temporarily lock the first and second lever arms in position with respect to each other. A user may thus close the blanket clamp by squeezing the two lower protruding handles of the first and second lever arms together so that the jaws of the first and second lever arms move closer together (i.e., to a closed position), with the cam of the thumb-actuated engagement lever ratcheting along the fixed tooth section, locking the lever arms in position with respect to each other at each step of the ratchet. To release the jaws, a user actuates the elongated portion of the thumb-actuated engagement lever to pull the cam from the fixed tooth portion and allow the torsion spring bias between the two lever arms to return the jaws to their open position.

The ratchet mechanism thus provides a mechanical stop or lock that prevents the jaws from moving apart from each other until a user affirmatively actuates the thumb-actuated engagement lever. Unlike conventional blanket clamps where movement of the insulating blanket may overcome the spring bias of the clamp, a wind gust or movement of the insulating blanket will not overcome the positive lock of the ratchet mechanism of the blanket clamp of the present invention.

### BRIEF DESCRIPTION OF THE DRAWINGS

The drawings constitute a part of this specification and include exemplary embodiments of the present invention illustrating various objects and features thereof.

FIG. 1 is a three-dimensional exploded isometric view of a preferred embodiment of the present invention.

FIG. 2 is a side elevational view of the embodiment thereof assembled.

FIG. 3 is a left side elevational view of a first half of the embodiment thereof.

FIG. 4 is a right side elevational view thereof.

FIG. 5 is a front elevational view thereof.

FIG. 6 is a rear elevational view thereof.

FIG. 7 is a top plan view thereof.

FIG. 8 is a button plan view thereof.

FIG. 9 is a left side elevational view of a second half of the embodiment thereof.

FIG. 10 is a right side elevational view thereof.

FIG. 11 is a front elevational view thereof.

FIG. 12 is a rear elevational view thereof.

FIG. 13 is a top plan view thereof.

FIG. 14 is a button plan view thereof.

FIG. 15 is a left side elevational view of a lever element of the embodiment thereof.

FIG. 16 is a front elevational view thereof.

FIG. 17 is a right side elevational view thereof.

FIG. 18 is a rear elevational view thereof.

FIG. 19 is a top plan view thereof.

FIG. 20 is a bottom plan view thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Blanket Clamp 2

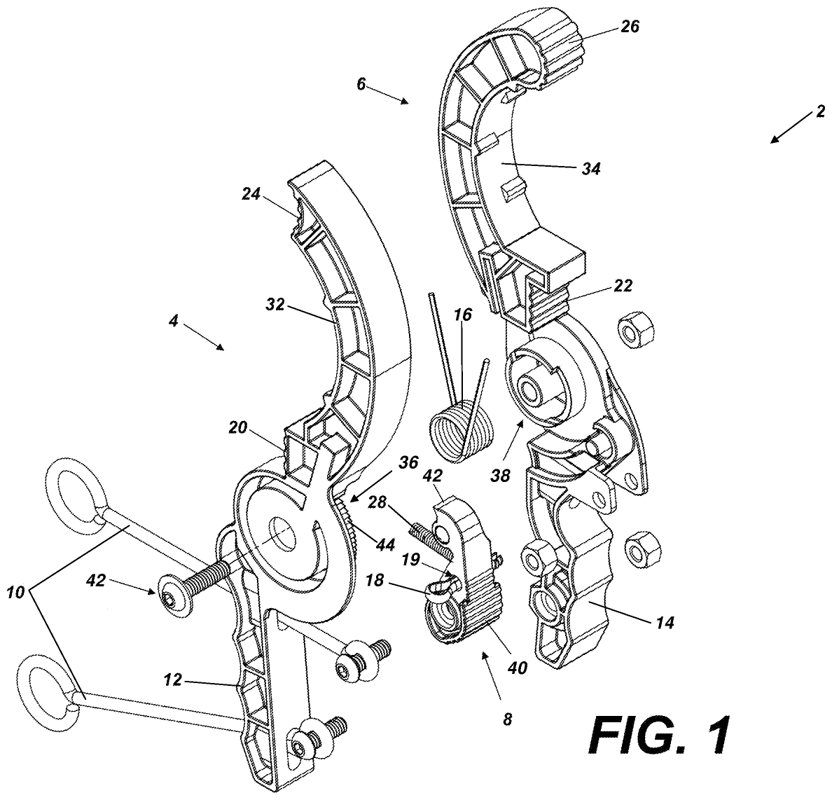

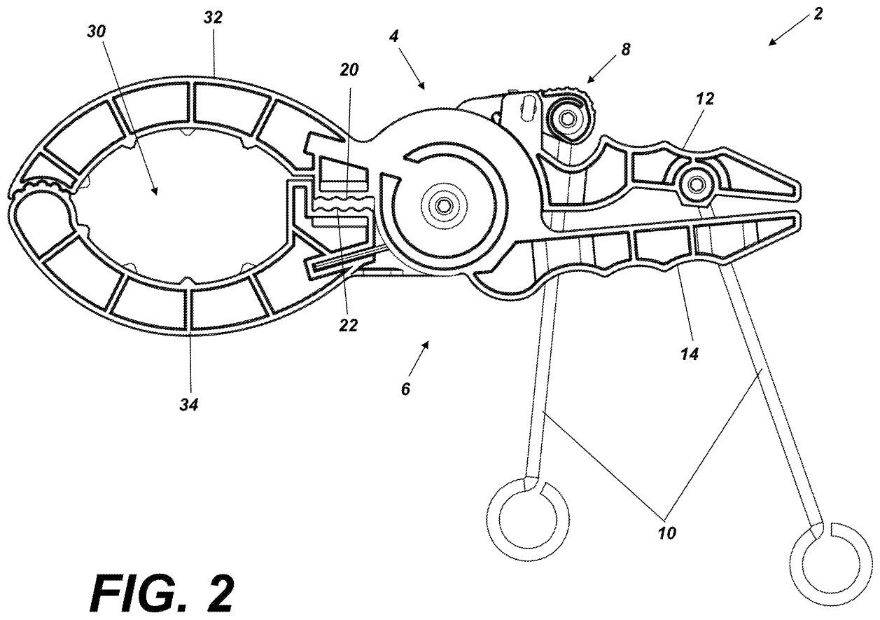

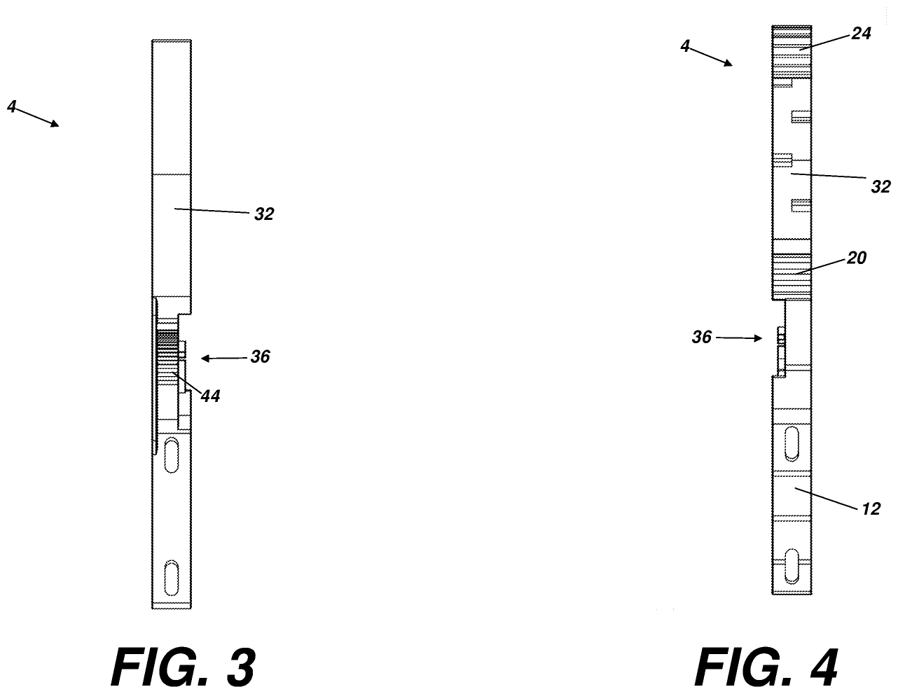

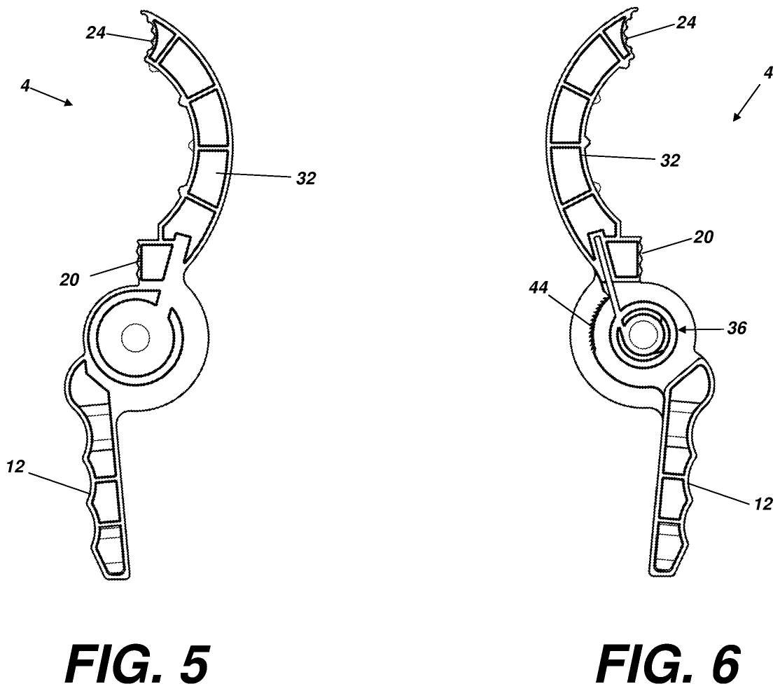

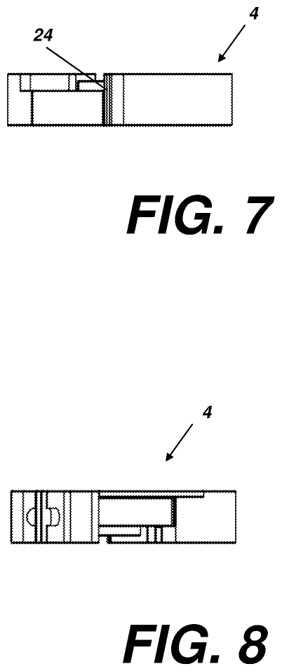

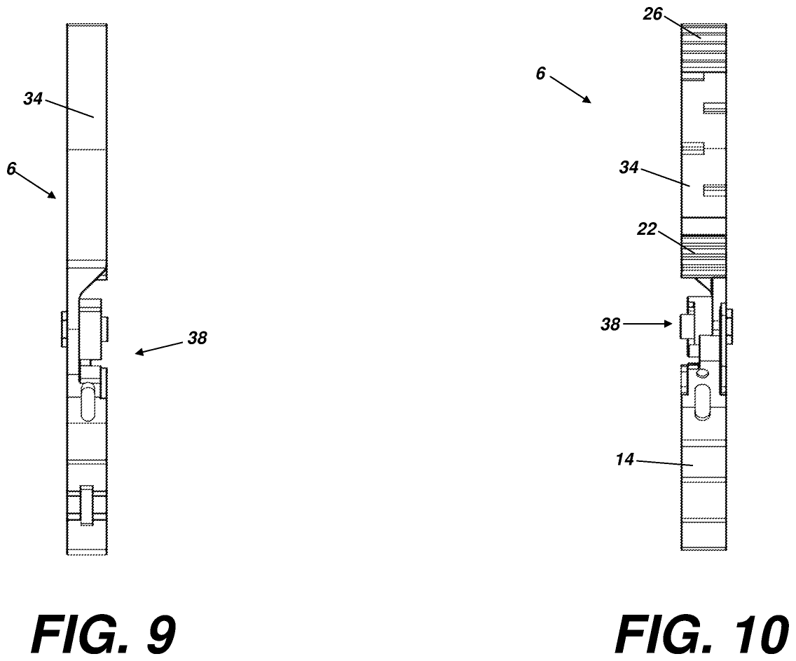

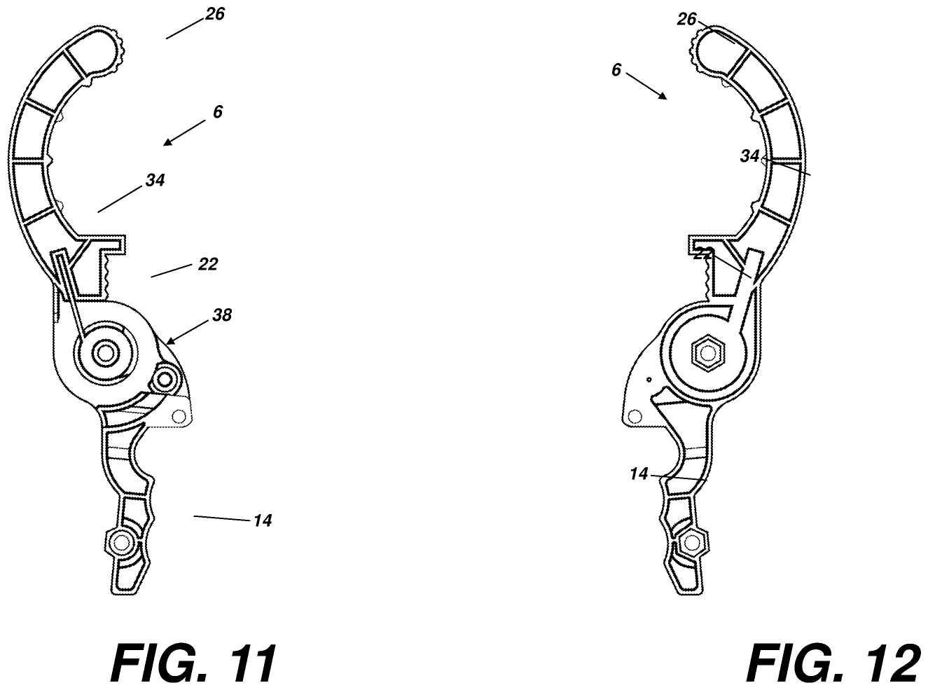

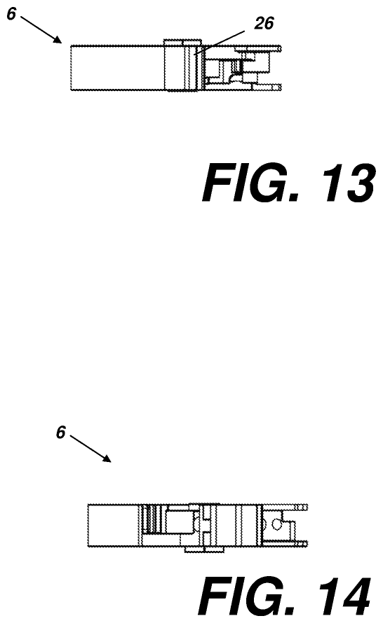

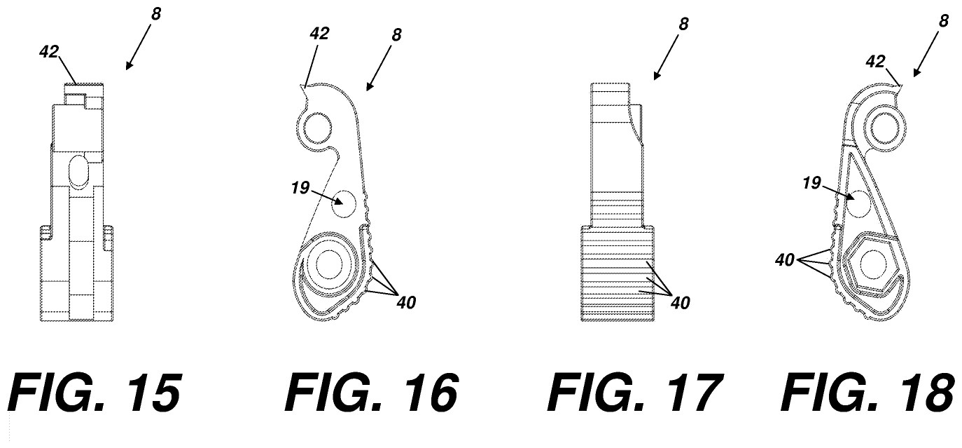

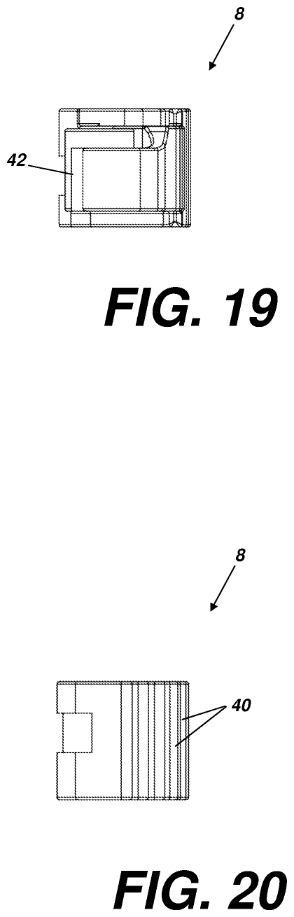

Referring to FIG. 1, the present invention is a blanket clamp 2 formed from a first lever arm 4 and a second lever arm 6 joined about a trigger element 8. A bolt 43 and torsion spring 16 join all the elements together along a pivot point axle defined by the bolt 43 to the useable form shown in FIG. 2. The first lever arm 4 has a first connector 36 which connects to the second connector 38 of the second lever arm 6 via the bolt 43. The trigger element 8 is similarly connected to the first lever arm 4 and second lever arm 6 via the bolt 43.

The first lever arm 4 has an elongated curvilinear arm forming a lower handle 12 and an upper jaw 32. The tip 24 of the upper jaw 32 forms a receiver with a number of arcuate members. The interior surface of the upper jaw 32 is intended to grip a blanket housed over an electrical conductor or some other suitable generally circular element.

The second lever arm 6 similarly has an elongated curvilinear arm forming a lower handle 14 and an upper jaw 34. The tip 26 of the upper jaw 34 forms an insert with a number of arcuate members intended to be received by the receiver of the first upper jaw 32. In the same manner, the interior surface of the upper jaw 34 is intended to grip a blanket housed over an electrical conductor or some other suitable generally circular element. Together, the two jaws 32, 34 secure about the generally circular element.

When joined as shown in FIG. 2, the two upper jaws 32, 34 are opposed such that they can be opened and closed by actuating the two lower handles 12, 14 together or apart, thereby rotating the first 4 and second 6 lever arms about the bolt 43. The two jaws 32, 34 define a space 30 which can be filled with a gripped object, such as a blanket surrounding an electrical wire.

The torsion spring 16 is placed about the central axis with the bolt 43 passing through it, with the two legs of the torsion spring positioned against the inner surfaces of each of the first 4 and second 6 lever arms. The torsion spring thus provides a bias force against each lever arm, forcing the upper portions of the two lever arms apart from each other, and thus forcing the upper jaws 32, 34 apart from each other so that the jaws are apart from each other. The clamp 2 is held in an open orientation until pressure is applied externally to the handles 12, 14 of the lever arms 4, 6, and are held closed using the trigger 8.

The first lever arm 4 includes a toothed portion 44 which can be engaged with the cam 42 of the trigger 8. When the bottom portion 40 of the trigger 8 is depressed, the cam 42 disengages from the toothed portion 44, allowing it to be opened or closed, depending upon its initial orientation. When released, the trigger 8 springs back via the trigger spring 28 such that the cam 42 engages with the toothed portion 44 of the first lever arm, thereby locking the upper jaws 32, 34 in whatever orientation they happen to be in when the trigger 8 is released. Ideally, this occurs when clamped about a blanket on an electrical element or some other suitable element. The toothed portion 44 and the cam 42 of the trigger 8 function as a ratchet mechanism. The trigger spring 28 is weaker than the torsion spring 16 such that the trigger 8 can be depressed and the clamp 2 can be opened.

A pin 18 can be inserted into the pin receiver 19 of the trigger add additional security to a locked-in place clamp 2.

The first lever arm 4 and second lever arm 6 have a first wire grip portion 20 and a second wire grip portion 22, respectively. As shown in FIG. 2, these wire grip portions 20, 22 interlock to allow the clamp 2 to clamp down onto wires of varying diameters. Typical clamps in the industry have pre-defined wire holes sized to specific wire types, but space is limited between the jaws of the clamp, and therefore it is ideal to have a wide away of wire grip options, which the wire grip portions 20, 22 of the present invention provide. As shown in FIG. 2, there is space between the wire grip portions 20, 22 when the clamp is in its closed orientation, the space being designed to fit the minimum necessary wire diameter.

A pair of shotgun loops 10 are connected to the clamp which can be used to grab and gather cables or wires. These may be adjustable about the handle portions of the lever arms.

The jaws of the lever arms could be covered with over-molded elements for further utility and protection.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A clamp system comprising:
a first lever arm comprising an elongated curvilinear arm forming a first lower handle and a first upper jaw, said first lever arm further comprising a toothed portion;
a second lever arm comprising an elongated curvilinear arm forming a second lower handle and a second upper jaw;
a torsion spring comprising a first leg positioned against an inner surface of said first lever arm and a second leg positioned against an inner surface of said second lever arm such that said torsion spring provides a bias force against each of said first and second lever arms, thereby forcing the first upper jaw and the second upper jaw apart;
said first lever arm, said second lever arm, and said torsion spring configured to be transformed between a first, open orientation based upon the bias force of said torsion spring and a second, closed orientation whereby both of said first and second lower handles of said first and second lever arms are depressed towards one another;
a trigger element disposed between said first lever arm and said second lever arm along a pivot axis;
a bolt connecting said first lever arm, said second lever arm, said torsion spring, and said trigger element about said pivot axis;
said trigger element comprising a cam and a trigger spring;
said trigger spring biased to pull said cam toward said toothed portion of said first lever arm, wherein said toothed portion comprises a plurality of toothed receivers each configured to receive said cam of said trigger element, whereby said cam and said toothed portion lock said first lever arm and said second lever arm in place about said pivot axis; and
whereby depressing said trigger element releases said cam, unlocking said first lever arm and said second lever arm about said pivot axis.

2. The clamp system of claim 1, further comprising:
said first lever arm comprising a first set of interlocking wire grips;
said second lever arm comprising a second set of interlocking wire grips; and
said first set of interlocking wire grips configured to oppose said second set of interlocking wire grips when said first lever arm and said second lever arm are in said second, closed orientation such that said first and second sets of interlocking wire grips are configured to grip onto wires having varying diameters.

3. The clamp system of claim 1, wherein said clamp is configured to grip a blanket about an electrical wire.

4. The clamp system of claim 1, further comprising:
a pair of shotgun loops connected to said first lower handle of said first lever arm; and
said pair of shotgun loops configure to receive electrical components.

5. A method of securing a blanket about an electrical wire, the method comprising the steps:
providing a clamp comprising a first lever arm and a second lever arm connected about a pivot axis;
wherein said first lever arm comprising an elongated curvilinear arm forming a first lower handle and a first upper jaw, said first lever arm further comprising a toothed portion;
wherein said second lever arm comprising an elongated curvilinear arm forming a second lower handle and a second upper jaw;
providing a torsion spring comprising a first leg positioned against an inner surface of said first lever arm and a second leg positioned against an inner surface of said second lever arm such that said torsion spring provides a bias force against each of said first and second lever arms, thereby forcing the first upper jaw and the second upper jaw apart;
said first lever arm, said second lever arm, and said torsion spring configured to be transformed between a first, open orientation based upon the bias force of said torsion spring and a second, closed orientation whereby both of said first and second lower handles of said first and second lever arms are depressed towards one another;
providing a trigger element disposed between said first lever arm and said second lever arm along said pivot axis;
connecting said first lever arm, said second lever arm, said torsion spring, and said trigger element about said pivot axis with a bolt;
wherein said trigger element comprising a cam and a trigger spring;
wherein said trigger spring is biased to pull said cam toward said toothed portion of said first lever arm;
wherein said toothed portion comprises a plurality of toothed receivers each configured to receive said cam of said trigger element, whereby said cam and said toothed portion are configured to lock said first lever arm and said second lever arm in place about said pivot axis;
depressing said trigger element, thereby releasing said cam and unlocking said first lever arm and said second lever arm about said pivot axis; and
releasing said trigger element, thereby biasing said cam toward said toothed portion, thereby locking said first lever arm and said second lever arm.

6. The method of claim 6, further comprising the steps:
providing a first set of interlocking wire grips within said first lever arm;
providing a second set of interlocking wire grips within said second lever arm;
wherein said first set of interlocking wire grips oppose second set of interlocking wire grips when said first lever arm and said second lever arm are in said second, closed orientation; and
gripping wires between said first and second sets of interlocking wire grips.

7. The method of claim 6, further comprising the steps:
placing a blanket over an electrical wire;
placing said first and second upper jaws over said blanket about said electrical wire;
depressing said trigger element and closing said clamp onto said blanket; and
releasing said trigger element, thereby securing said blanket about said electrical wire.
